(19) United States
(12) Patent Application Publication
(10) Pub. No.: US 2025/0332853 A1
(43) Pub. Date: Oct. 30, 2025

(54) INK JET RECORDING APPARATUS

(71) Applicant: CANON KABUSHIKI KAISHA, Tokyo (JP)

(72) Inventors: SHOICHI ZENSAI, Kanagawa (JP); TOMOHIRO SUZUKI, Tokyo (JP); TOSHIKAZU MURAMATSU, Tokyo (JP)

(21) Appl. No.: 19/191,998

(22) Filed: Apr. 28, 2025

(30) Foreign Application Priority Data
Apr. 30, 2024 (JP) 2024-074130

(51) Int. Cl. B41J 29/13; B41J 2/175; B41J 11/00; B41J 29/377

(52) U.S. Cl. CPC B41J 29/13; B41J 2/175; B41J 11/002; B41J 29/377

(57) ABSTRACT

An ink jet recording apparatus includes a conveyance path configured to convey a recording medium, an action unit configured to act on the recording medium, capable of being opened and closed to the conveyance path, a driving input unit to which driving force for opening and closing the action unit is input, and a transmission unit configured to transmit the driving force to the unit from the driving input unit, wherein the transmission unit includes a locking unit configured to prevent the action unit in an opened state from being closed.

### BACKGROUND

### Field

The present disclosure relates to an ink jet recording apparatus.

### Description of the Related Art

In ink jet recording apparatuses, there has been a known method of heating and drying recording media with ink applied thereon at a drying unit including a heating unit and a blowing unit in order to improve productivity as discussed in Japanese Patent Application Laid-Open No. 2011-037143.

The drying unit discussed in Japanese Patent Application Laid-Open No. 2011-037143 can heat and dry recording media with a heater arranged on a platen included in a conveyance unit. Further, the blowing unit disposed on an openable/closable cover, which covers the platen and the conveyance unit, improves the drying efficiency.

In recent years, an ink jet recording system has been used in commercial/industrial recording apparatuses. These recording apparatuses are large, so that the size and the weight of the cover are also increased. Thus, there has been a demand for an opening/closing mechanism with a higher level of safety and operability, which allows a user to avoid manually opening the cover directly.

### SUMMARY

The present disclosure is directed to an ink jet recording apparatus with higher operability.

According to some embodiments, an ink jet recording apparatus includes a conveyance path configured to convey a recording medium, an action unit configured to act on the recording medium, capable of being opened and closed to the conveyance path, a driving input unit to which driving force for opening and closing the action unit is input, and a transmission unit configured to transmit the driving force to the action unit from the driving input unit, wherein the transmission unit includes a locking unit configured to prevent the action unit in an opened state from being closed.

Further features of the present disclosure will become apparent from the following description of exemplary embodiments with reference to the attached drawings.

### BRIEF DESCRIPTION OF THE DRAWINGS

FIG. 1 is a cross-sectional diagram illustrating an internal configuration of an ink jet recording apparatus according to a first exemplary embodiment.

FIG. 2 is a diagram illustrating a perspective view of a housing of a sheet conveyance unit included in a recording unit according to the first exemplary embodiment.

FIG. 3 is a schematic diagram illustrating a lifting mechanism for a recording head according to the first exemplary embodiment.

FIGS. 4A and 4B are cross-sectional diagrams illustrating configurations of a drying unit according to the first exemplary embodiment.

FIG. 5 is a schematic plan view of a configuration of an airflow space within the drying unit according to the first exemplary embodiment.

FIG. 6 is a cross-sectional diagram illustrating a configuration of an airflow duct of a cooling unit according to the first exemplary embodiment.

FIG. 7 is a schematic diagram illustrating a configuration of a first recording unit.

FIG. 8 is a schematic diagram illustrating a relative positional relationship between the first recording unit and a second recording unit.

FIG. 9 is a block diagram illustrating details of a control unit.

FIGS. 10A to 10C are diagrams illustrating perspective views of a drying/cooling unit according to the first exemplary embodiment.

FIGS. 11A to 11E are plan views and perspective views of an access cover being opened.

FIGS. 12A to 12C are perspective views of a mechanism for opening and closing the access cover.

FIGS. 13A to 13C are partially enlarged diagrams illustrating operations of a third driving unit.

FIG. 14 is a block diagram illustrating an example of the control unit.

FIGS. 15A to 15C are diagrams illustrating perspective views of an auxiliary elastic member for opening and closing the access cover.

FIGS. 16A to 16D are enlarged diagrams illustrating an example of a handle.

FIGS. 17A and 17B are enlarged diagrams illustrating another example of the handle.

FIG. 18 is a block diagram illustrating another example of the control unit.

FIGS. 19A and 19B are diagrams illustrating a configuration example of a fixing unit according to the first exemplary embodiment.

FIG. 20A is a diagram illustrating a mechanism for opening and closing the access cover, and FIG. 20B is a graph illustrating opening angles of the access cover according to a second exemplary embodiment.

FIG. 21 is a schematic diagram illustrating a relative positional relationship between the first recording unit and the second recording unit according to a third exemplary embodiment.

FIGS. 22A to 22C are schematic diagrams each illustrating a relationship between the moment acting on the access cover and the elastic member according to the third exemplary embodiment.

FIG. 23 is a graph illustrating a relationship between an opening angle of the access cover and an operation force.

### DESCRIPTION OF THE EMBODIMENTS

Hereinafter, various exemplary embodiments, features, and aspects of the present disclosure will be described in detail with reference to the drawings. The constituent elements described in the exemplary embodiments below are merely examples, and a configuration and various conditions of an apparatus to which the present disclosure is to be applied can be modified or changed as appropriate without departing from the spirit of the present disclosure. Thus, the present disclosure is not limited to the exemplary embodiments described below. For example, dimensions, materials, shapes, and relative arrangements of the constituent elements described in the exemplary embodiments can be changed as appropriate depending on the configuration and the various conditions of an apparatus to which the present disclosure is applied, and the scope of the present disclosure is not limited to the exemplary embodiments unless specific limitations are described in particular.

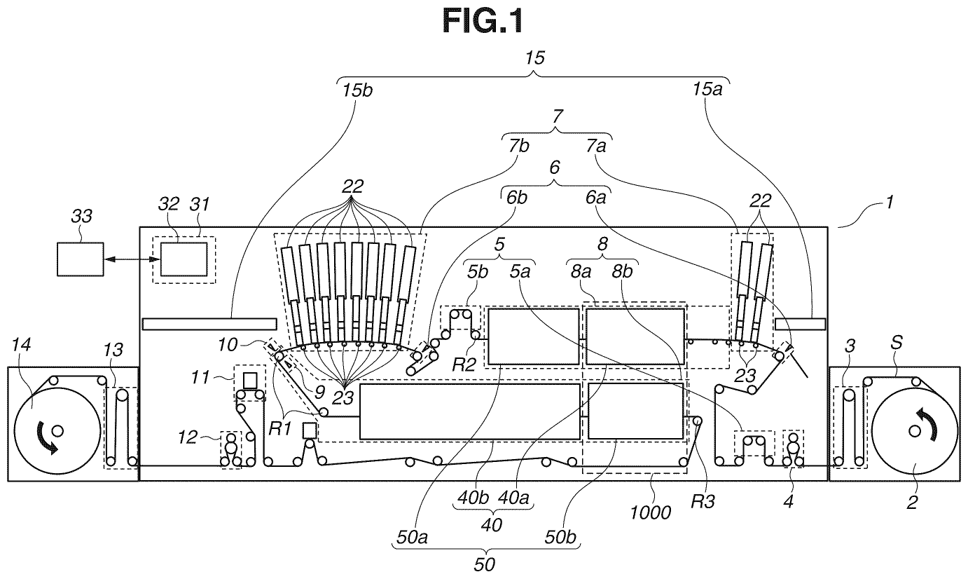

A first exemplary embodiment will now be described. First, the upper part of an apparatus in FIG. 1 is defined as “the upper part”, a direction from the right to the left of the apparatus as “a longitudinal direction”, and a direction from the front to the rear of the drawing orthogonal to a conveyance direction of a recording medium as “a sheet width direction”. Further, the conveyance of a recording medium in a direction from an unwinding roll unit 2 to a winding roll unit 14 is defined as “a forward direction conveyance”, and the conveyance of a recording medium in the direction opposite to the direction of the forward direction conveyance as “a backward direction conveyance”. A recording apparatus 1 according to the present exemplary embodiment is a high-speed line printer which uses a continuous sheet wound in a roll shape as a recording medium. A cut sheet can be used as a recording medium instead of the continuous sheet.

### <Ink Jet Recording Apparatus>

FIG. 1 is a schematic cross-sectional diagram illustrating an internal configuration of the recording apparatus 1. The recording apparatus 1 includes a unwinding roll unit 2, a first dancer-roller unit 3, a first main conveyance unit 4, a meandering correction unit 5, a conveyance detection unit 6, a recording unit 7, a conveyance tension detection unit 9, a recorded image position detection unit 10, a scanner unit 11, a second main conveyance unit 12, a second dancer-roller unit 13, a winding roll unit 14, a maintenance unit 15, a drying unit 40, and a cooling unit 50. A continuous sheet S used as a recording medium is conveyed along a sheet conveyance path indicated by a solid line in FIG. 1, and subjected to processing at each unit. Hereinafter, all units described above together are also called “an entire unit”, an access cover described below “an upper unit”, and the rest including a conveyance path “a lower unit”.

The recording apparatus 1 according to the present exemplary embodiment includes a first image forming unit and a second image forming unit arranged along the sheet conveyance path (a sheet S). The first image forming unit records images to be fixed to sheets S through a first recording unit 7a, a first drying unit 40a, and a first cooling unit 50a. The second image forming unit records images to be fixed to the sheet S through the first image forming unit, a second recording unit 7b, a second drying unit 40b, and a second cooling unit 50b. As described above, the recording apparatus 1 passes the sheet S through the first image forming unit and the second image forming unit to enable continuous image recording on the sheet S. Further, the recording apparatus 1 can selectively determine the image forming unit to be used depending on the recording condition. In this case, the selected image forming unit alone records images on the sheet S.

The unwinding roll unit 2 holds and supplies a continuous sheet wound in a roll shape. The unwinding roll unit 2 stores a roll of sheet paper, and the sheet S is pulled and supplied from the unwinding roll unit 2. However, the number of rolls storable is not limited to one. The unwinding roll unit 2 can store a plurality of rolls, and a sheet S can selectively be pulled and supplied from the unwinding roll unit 2.

The first dancer-roller unit 3 applies a certain sheet tension to the sheet S between the unwinding roll unit 2 and the first main conveyance unit 4. The first dancer-roller unit 3 applies sheet tension using a not-illustrated tension application unit.

The first main conveyance unit 4 conveys the sheet S to units arranged along the sheet conveyance path (the sheet S) and applies sheet tension to the sheet S between the first main conveyance unit 4 and the second main conveyance unit 12. The first main conveyance unit 4 is driven and rotated by a not-illustrated motor to convey the sheet S while applying tension thereto (i.e., tension conveyance).

The meandering correction unit 5 corrects meanders of the sheet in the sheet width direction when the sheet S is tensioned and conveyed. In the present exemplary embodiment, the meandering correction unit 5 includes a first meandering correction unit 5a and a second meandering correction unit 5b. The first and the second meandering units 5a and 5b are respectively arranged upstream of the first and the second image forming units along the sheet conveyance path. The meandering correction unit 5 includes meandering correction rollers and not-illustrated meandering detection sensors for detecting meanders of the sheet S. The meandering correction roller can change its angle with respect to the sheet S by a not-illustrated motor, and corrects the meandering of the sheet S based on measurements from a meandering detection sensor. Winding the sheets S around the meandering correction rollers enhances the functionality of the meandering correction.

The conveyance detection unit 6 detects the conveyance speed of the sheet S and marks pre-printed on the sheet S to control the image forming timing of the recording unit 7. In the present exemplary embodiment, the conveyance detection unit 6 is provided with a first conveyance detection unit 6a and a second conveyance detection unit 6b upstream of the first and second image forming units, respectively, in the sheet conveyance path. The first and the second conveyance detection units 6a and 6b are respectively used for controlling the timings of image formations performed by the first and the second recording units 7a and 7b.

The recording unit 7 is a sheet processing unit that forms images by applying a liquid composite material (i.e., ink) on the sheet S from above using recording heads 22. The sheet conveyance path in the recording unit 7 includes guide rollers 23 arranged in an arc shape curved upward, and a certain tension is applied to the sheet S. Thus, the clearance between the sheet S and the recording heads 22 is maintained. The recording heads 22 are arranged in parallel in the conveyance direction. In the present exemplary embodiment, the first recording unit 7a includes two line-type recording heads 22 in total, i.e., one for a white (W) ink and the other for a reaction liquid. The second recording unit 7b includes eight line-type recording heads 22 in total, for four colors, i.e., black (Bk), yellow (Y), magenta (M), and cyan (C), a reaction liquid, and three spot-colors.

The reaction liquid contains a component to increase the viscosity of ink. Increased viscosity of ink refers to a phenomenon where a color material and a resin in ink come into contact with a component that increases viscosity of ink, resulting in a chemical reaction or physical adsorption, which leads to an increase in the viscosity of ink. Increased viscosity of ink includes a case where a viscosity of ink is entirely increased, as well as a case where a viscosity of ink is partially increased due to partial aggregation of components, such as the color material and the resin in the ink. Components (reactants) which cause an increase in ink viscosity are not limited in particular, and any materials that change pH of ink to coagulate color materials in ink can be used, for example, polyvalent metal ions, cationic components, such as cationic resin, and organic acid. The reaction liquid applied to the sheet S before ink is applied thereto can immediately fix ink once the ink reaches the sheet S. This prevents bleeding, a phenomenon that ink is mixed with the adjacent ink. In addition, the types of colors, the number of colors, and the number of recording heads 22 are not limited. An ink jet method can be a method using a heating element, a piezoelectric element, an electrostatic element, or a micro-electromechanical system (MEMS) element. Ink is supplied to the recording heads 22 from not-illustrated ink tanks through ink tubes.

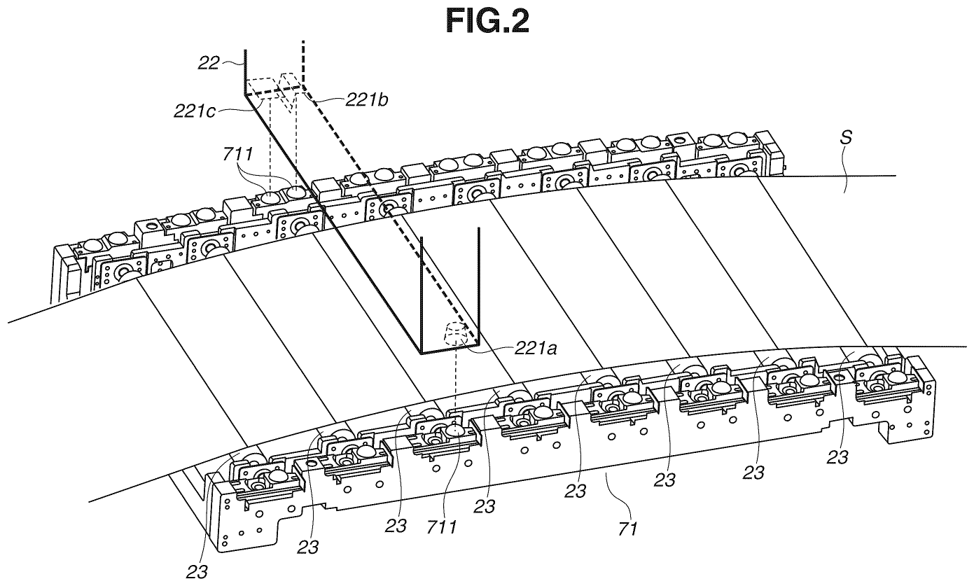

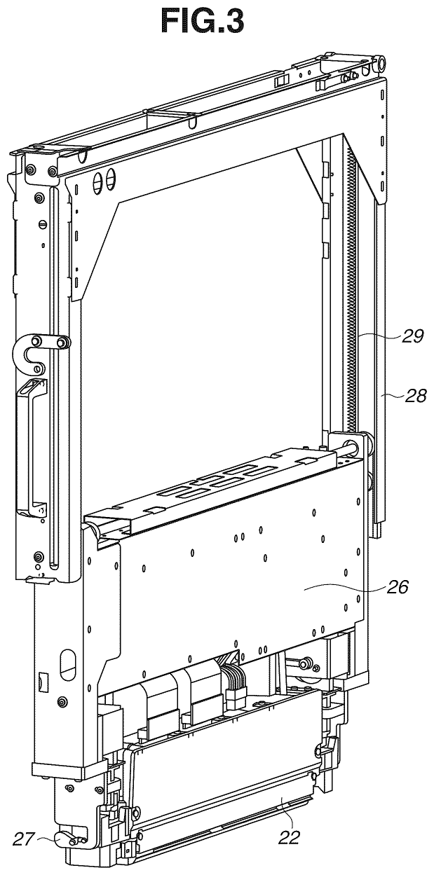

As illustrated in FIG. 2, a plurality of recording head positioning members 711 for positioning the recording heads 22 is arranged on a housing 71 of a sheet conveyance unit included in the recording unit 7. The positioning members 711 are provided one on the front and two on the rear of each of the recording heads 22 across the sheet S in the sheet width direction. Further, as illustrated in FIG. 3, each recording head 22 is axially supported in such a manner that a recording head holding unit 26, which holds and moves the recording head 22 up and down, is supported from below by a recording head supporting shaft 27. The recording head holding unit 26 is moved up and down by a not-illustrated driving mechanism internally mounted on the recording head holding unit 26 along up-and-down rails 29 arranged inside a recording head up-and-down frame 28. In the present exemplary embodiment, ink is applied to the sheet S by using an ink jet head. However, a method of applying ink to the sheet S at the recording unit 7 is not limited thereto. For example, while the reaction liquid is applied by the recording head 22 in the present exemplary embodiment, the reaction liquid can be applied by a roller, a die coating apparatus (a die coater), or a blade coating apparatus (a blade coater).

As illustrated in FIG. 1, the conveyance tension detection unit 9 detects tension during tension conveyance between the first main conveyance unit 4 and the second main conveyance unit 12. The recorded image position detection unit 10 detects misalignments of images formed on the sheet S by the recording unit 7 during printing and causes the recording apparatus 1 to correct the printing.

Winding guide rollers R1 wind the surface of the sheet S opposed to the surface with ink applied thereon downstream in a conveyance direction of the second recording unit 7b at certain winding angles. In the present exemplary embodiment, the two winding guide rollers R1 are arranged between the second recording unit 7b and the second drying unit 40b. The sheet S is turned at the rollers to be substantially parallel to each other. The second drying unit 40b is arranged downstream of the second recording unit 7b.

The drying unit 40 (the first drying unit 40a and the second drying unit 40b) reduces the amount of the liquid component included in the liquid applied to the sheet S at the recording unit 7 to improve fixability of ink to the sheet S. The drying unit 40 blows air heated by heaters to the recorded sheet S and dries the ink applied to the sheet S at a predetermined drying temperature. The drying unit 40 blows air to the sheet S passing through the drying unit 40, at least to the surface with ink applied thereon, to dry the surface. Further, the drying method can be a method of blowing air, of irradiating at least one surface of the sheet S with electromagnetic rays (such as ultraviolet rays or infrared rays), of conducting/transmitting heat generated by a contact of a heat generation member with the sheet S, or a combination of those methods.

The cooling unit 50 (the first cooling unit 50a and the second cooling unit 50b) cools the sheet S on which ink is fixed by the drying unit 40 to solidify the softened ink and to reduce a change in temperatures of the sheet S downstream of the recording apparatus 1. The cooling unit 50 blows air having a temperature lower than that of the sheet S to the sheet S passing through the cooling unit 50, at least to the surface with ink applied thereon, to cool the surface. The cooling method is not limited to a method of blowing air, and can be a method of conducting/transmitting heat generated by a contact of a heat dissipation member with the sheet S, or a combination of those methods. Further, air can be blown to both the surfaces of the sheet S in order to improve the cooling efficiency for the sheet S.

The second main conveyance unit 12 conveys the sheet S while applying tension to the sheet S and the first main conveyance unit 4, and adjusts the tension applied to the sheet S. The second main conveyance unit 12 is driven and rotated by a not-illustrated motor to control the speed at the second main conveyance unit 12 in accordance with a tension value detected by the conveyance tension detection unit 9 controlled by a not-illustrated tension control unit. As a constituent element which adjusts the tension of the sheet S, a not-illustrated drivingly connected clutch capable of controlling torque can be provided. In this case, the recording apparatus 1 has two tension control methods: a torque control method of controlling the torque values transmitted from the clutch, and a speed control method of controlling the speed of the rollers of the second main conveyance unit 12. Thus, the recording apparatus 1 can switch the tension control methods, or simultaneously use both of the methods depending on the purpose.

The second dancer-roller unit 13 applies a certain sheet tension to the sheet S between the second main conveyance unit 12 and the winding roll unit 14. The second dancer-roller unit 13 applies sheet tension to the sheet S using a not-illustrated tension application unit.

The winding roll unit 14 winds the sheets S subjected to the recording processing around a winding core. The number of collectable rolls is not limited to one. The winding roll unit 14 can have a plurality of winding cores, and switch the selected winding cores to collect the sheet. The winding roll unit 14 is individually controlled to be rotated in a normal rotation direction and a reverse rotation direction by a driving motor (not illustrated). The unwinding roll unit 2 and the winding roll unit 14 are controlled to be rotated in the normal rotation direction or the reverse rotation direction by the respective driving motors (not illustrated), so that the sheet S is conveyed in the forward direction or the backward direction. When the sheet S is conveyed in the backward direction, tension conveyance is performed between the first main conveyance unit 4 and the second main conveyance unit 12 in the same manner as that of conveyance of the sheet S in the forward direction. Further, depending on the processing after recording, a continuous sheet can be cut into sheets by a cutter so that the sheets S are stacked, instead of being wound around the winding roll.

A control unit 31 generally controls the units of the recording apparatus 1. The control unit 31 includes a central processing unit (CPU), a storage device, a controller including various control units, an external interface, and an operation unit 32 for allowing a user to perform input/output operations. The operation of the recording apparatus 1 is controlled based on instructions issued by the control unit 31 or a host computer, such as a host apparatus 33, connected to the control unit 31 via the external interface.

A maintenance unit 15 includes a mechanism for restoring discharge performance of the recording heads 22. Examples of such a mechanism include a cap mechanism for protecting the ink discharge surface of the recording heads 22, a wiper mechanism for wiping the ink discharge surface, and a suction mechanism for suctioning ink within the recording heads 22 from the ink discharge surface by applying negative pressure. The maintenance unit 15 includes a driving mechanism and a not-illustrated rail, so that the maintenance unit 15 can reciprocate in the horizontal directions along the rail. The maintenance unit 15 is moved directly below the recording heads 22 during a maintenance of the recording heads 22, and away from the position directly below the recording heads 22 when the maintenance is not being performed. In the present exemplary embodiment, a first maintenance unit 15a and a second maintenance unit 15b are respectively arranged for the first recording unit 7a and the second recording unit 7b.

### <Configuration of Drying Unit 40>

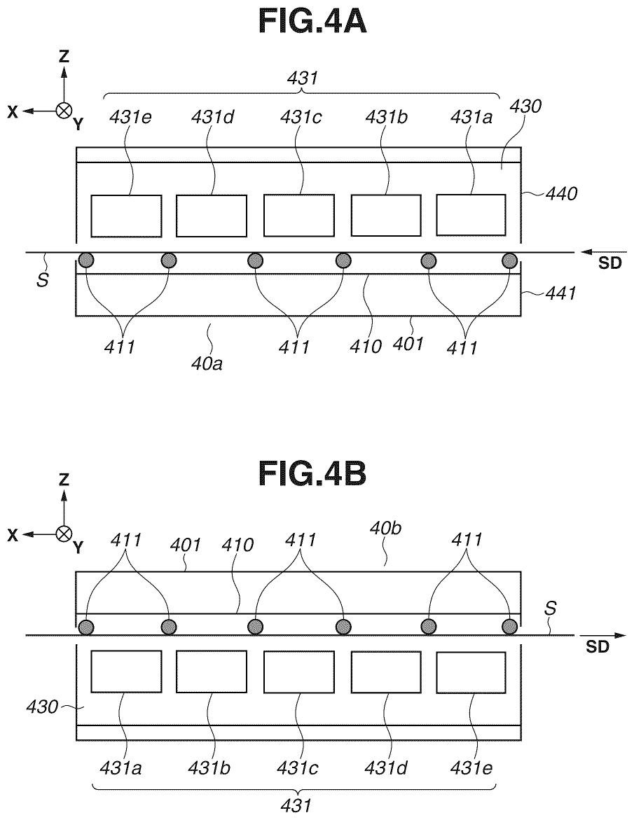

A mechanism for airflow application at the drying unit 40 will be described in detail. FIGS. 4A and 4B are schematic cross-sectional diagrams illustrating internal configurations of the drying unit 40 as viewed in the sheet width direction (a Y direction). FIG. 4A illustrates the first drying unit 40a, and FIG. 4B illustrates the second drying unit 40b. In FIGS. 4A and 4B each, a sheet conveyance direction is defined as an SD direction, the sheet width direction as the Y direction, a direction heading to the left from the right of the recording apparatus 1 a +X direction, and a direction heading to the upper part from the bottom of the recording apparatus 1 as a +Z direction.

The drying unit 40 includes housings 401. The housings 401 each includes a sheet supporting unit 410 in which sheet supporting rollers 411 are arranged so as to come in contact with the sheet S being conveyed, and an airflow space 430. The sheet supporting unit 410 restricts displacement of the sheet S in the Z direction using the sheet supporting rollers 411. In the first drying unit 40a, the airflow space 430 is provided above the surface of the conveyed sheet S opposite to the surface facing the sheet supporting unit 410 at an interval in the +Z direction. In the second drying unit 40b, the airflow space 430 is provided below the surface of the conveyed sheet S opposite to the surface facing the sheet supporting unit 410 at an interval in the −Z direction. The airflow space 430 according to the present exemplary embodiment of the present disclosure refers to a space where one or more airflow ducts are accommodated.

In the present exemplary embodiment, five airflow ducts 431a to 431e are arranged inside the airflow space 430. Based on a desired productivity (i.e., a conveyance speed of the sheet S), the drying unit 40 according to the present exemplary embodiment includes a plurality of housings 401 arranged in parallel in the SD directions. In addition, the numbers of airflow spaces 430, airflow ducts 431, and housings 401 are not limited. An internal configuration of the first drying unit 401a will be described below in detail.

### (Configuration of Airflow Space 430)

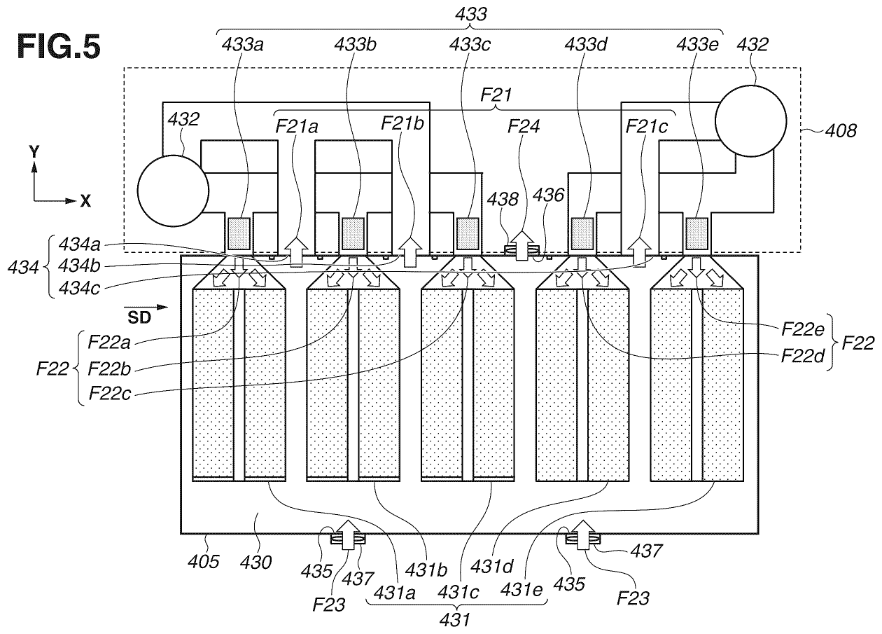

A configuration of the airflow space 430 will now be described with reference to FIG. 5. The definition of directions in FIG. 4 is applied to those in FIG. 5. FIG. 5 is a schematic diagram illustrating the airflow space 430 viewed in the +Z direction from the sheet S. The airflow space 430 includes a second housing 405 and a plurality of airflow ducts 431a to 431e accommodated inside the second housing 405. The second housing 405 includes a connection path (not illustrated) for sending air to the airflow ducts 431, circulating exhaust openings 434, ventilation openings 435, and an exhaust opening 436.

An air circulation heating unit 408 including blowing devices 432 and heaters 433 is disposed outside the airflow space 430. The blowing devices 432 take in air within the airflow space 430 from the circulating exhaust openings 434 in an F21 direction. The air taken therein is blown to an F22 direction and heated through the heaters 433. The temperature of the heated air is detected by a not-illustrated air temperature detection unit. The heating temperatures of the heaters 433 are controlled according to a predetermined target temperature based on the temperature detected by the air temperature detection unit.

In the present exemplary embodiment, the temperature of the air through the heaters 433 is controlled within the range of 50 degrees Celsius (° C.) to 100° C. The heated air flows in the F22 direction, and is blown to the sheet S from the airflow ducts 431. The airflow ducts 431 have a plurality of regularly formed small-diameter circular holes (e.g., 1.5 millimeter (mm) to 5 mm), so that the air is uniformly blown to the sheet S through the circular holes. Further, the shape of the holes formed on the airflow ducts 431 is not limited to a circular shape, and can be a slit in a linear shape or a hole in an oval shape, and holes in different shapes may be formed in combination.

When the liquid component of the ink applied to the sheet S is evaporated, the pressure within the airflow space 430 is increased. The excessively increased pressure within the airflow space 430 prevents a desired amount of evaporation from being achieved, so that a drying failure occurs. Thus, external air is taken in through air inlet fans 437 provided in the second housing 405, and the recording apparatus 1 is ventilated by the air containing accumulated stream being expelled through an exhaust fan 438.

The air inlet fans 437 take in external air through openings (not illustrated) of the recording apparatus 1 in an F23 direction, and supply the air into the airflow space 430 through the ventilation openings 435. The exhaust fan 438 exhausts air from the airflow space 430 through the exhaust opening 436 in an F24 direction. The exhausted air is discharged to the outside of the drying unit 40. In the present exemplary embodiment, while ventilation is performed using the air inlet fans 437 and the exhaust fan 438, the configuration is not limited thereto. For example, ventilation can be performed by either the fans 437 or 438. The ventilation openings 435 and the exhaust opening 436 can both be arranged in the air circulation heating unit 408.

The airflow space 430 can employ a desired drying method for blowing air to the sheet S. For example, the airflow ducts 431 and the air circulation heating unit 408 are not limited to those described in the present exemplary embodiment, and can be implemented with a desired number, desired blowing units, and desired heating units, as well as use or a combination with a drying method using a radiant heater. While heated air is circulated by the heaters 433 in the present exemplary embodiment, the air circulation heating unit 408 may not include the heaters 433, and may circulate air at a normal temperature.

### (Control Procedure of Drying Unit 40)

A control procedure for the drying unit 40 implemented by the control unit 31 will be described. When the host apparatus 33 transmits recording data to the control unit 31, the recording apparatus 1 starts a recording preparation operation. Based on a recording condition, the control unit 31 determines a driving table value of the drying unit 40. A condition of the driving table is determined based on a recording medium, a recording density, and a value specified by the user. An airflow temperature of each of the airflow ducts 431 and a driving duty of an air-supply source are specified based on a condition of the driving table. The duty refers to a driving pulse duty cycle of an air-supply source, and driving signals are output in the range from stop (0%) to full-speed rotation (100%). In the present exemplary embodiment, the air volume of each of the airflow ducts 431 is adjusted by the driving duty of the air-supply source. However, the present exemplary embodiment of the present disclosure is not limited to this method. For example, a not-illustrated nozzle internal pressure detection unit is arranged inside each of the airflow ducts 431, and a pressure value inside the nozzles is set to be a target value. Then, feedback control can be performed on the air-supply source based on the detected pressure value.

### <Configuration of Cooling Unit 50>

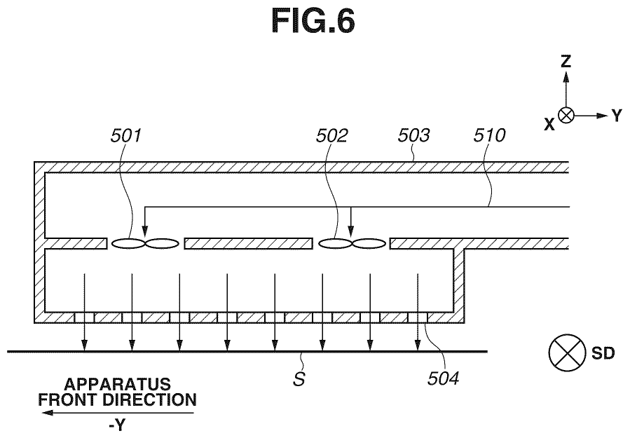

A configuration of the cooling unit 50 will be described in detail. Similarly to the drying unit 40, the cooling unit 50 of the present exemplary embodiment includes a plurality of airflow ducts which includes an air-cooling unit. FIG. 6 is a schematic cross-sectional diagram illustrating an example of an internal configuration of the cooling unit 50 viewed in the sheet width direction (i.e., the Y direction). The definition of directions in FIG. 4 is applied to that in FIG. 6. Fans 501 and 502 are arranged in an air path formed in a cooling airflow duct 503. Air is taken in from the exterior of the recording apparatus 1 and blown to the sheet S on the conveyance path through nozzles 504 as indicated by arrows 510 in FIG. 6.

### (Control Procedure of Cooling Unit 50)

A control procedure for the cooling unit 50 implemented by the control unit 31 will be described. When the host apparatus 33 transmits recording data to the control unit 31, the recording apparatus 1 starts a recording preparation operation. Based on a recording condition, the control unit 31 determines a driving table value of the cooling unit 50. A condition of the driving table is determined based on a recording medium, a recording density, and a value specified by the user. Driving duties of the fans 501 and 502 included in the cooling airflow duct 503 are each specified based on a condition of the driving table. The duty refers to a driving pulse duty cycle of each of the fans 501 and 502, and driving signals are output in the range from stop (0%) to full-speed rotation (100%). In the present exemplary embodiment, an air volume in the cooling airflow duct 503 is adjusted by the driving duty of each of the fans 501 and 502. However, the exemplary embodiment of the present disclosure is not limited to this method. For example, a not-illustrated nozzle internal pressure detection unit is disposed inside the cooling airflow duct 503, and pressure values inside the nozzles are set to be target values. Then, feedback control can be performed on the air-supply source based on the detected pressure values.

### <Configuration of the First Recording Unit>

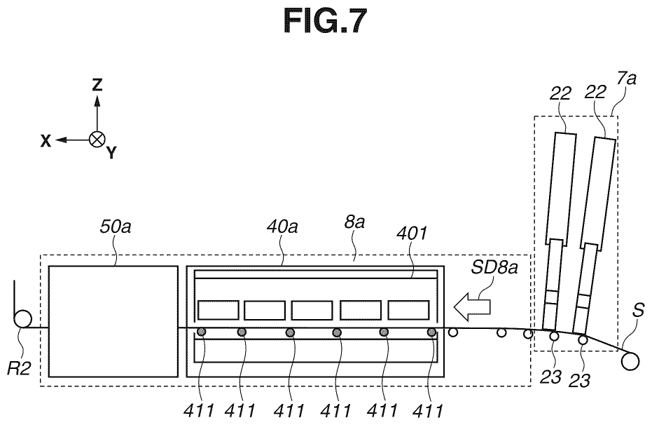

A configuration of a first recording unit will be described in detail with reference to FIG. 7. The first recording unit includes the first recording unit 7a and a first conveyance path 8a arranged downstream of the first recording unit 7a in the conveyance direction. The first conveyance path 8a leads the sheet S to a contact roller R2 after ink is applied to the sheet S at the first recording unit 7a. The first conveyance path 8a includes the first drying unit 40a and the first cooling unit 50a. In FIG. 7, a sheet conveyance direction in the first conveyance path 8a is defined as an SD8a direction, and the definition of other directions of FIG. 4 applies to that of FIG. 7.

At the first recording unit, the reaction liquid and the white (W) ink are applied to the sheet S in that order by the first recording unit 7a. After ink is applied to the sheet S, the sheet S is heated and dried by the first drying unit 40a arranged on the first conveyance path 8a to fix the ink to the sheet S. The contact roller R2 for forming a sheet conveyance path is arranged in the SD8a direction of the first conveyance path 8a. The surface of the sheet S with ink applied thereon comes into contact with the surface of the contact roller R2. To keep the surface layer of the sheet S with ink applied thereon in a good condition, the ink is desirably solidified before the sheet S reaches the contact roller R2. In the present exemplary embodiment, the first cooling unit 50a is arranged downstream of the first drying unit 40a in the first conveyance path 8a, so that the ink is solidified before the sheet S reaches the contact roller R2.

### <Configuration of the Second Recording Unit>

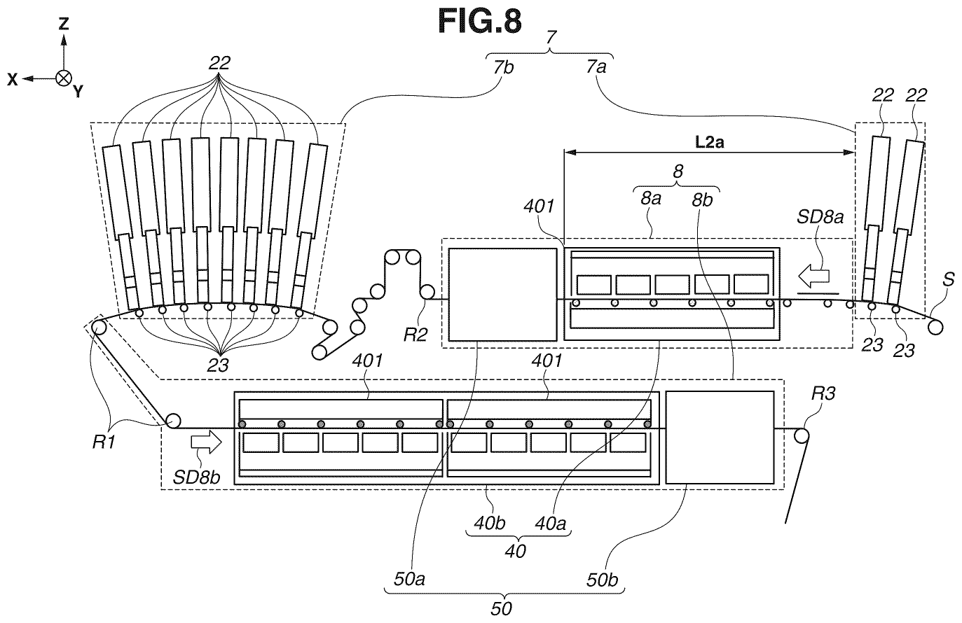

A configuration of a second recording unit will be described in detail with reference to FIG. 8. FIG. 8 is a schematic diagram illustrating a relative positional relationship between the first recording unit and the second recording unit. The second recording unit includes the second recording unit 7b and a second conveyance path 8b arranged downstream of the second recording unit 7b in the conveyance direction. The second conveyance path 8b leads the sheet S to a contact roller R3 after ink is applied to the sheet S at the second recording unit 7b. The second conveyance path 8b includes the winding guide rollers R1, the second drying unit 40b, and the second cooling unit 50b. In FIG. 8, a sheet conveyance direction in the second drying unit 40b is defined as an SD8b direction, and the definition of other directions of FIG. 4 applies to that of FIG. 8.

In the second recording unit, the reaction liquid and color inks based on a recorded image are applied to the sheet S in that order by the second recording unit 7b. The cyan ink, the magenta ink, the yellow ink, and the black ink, as well as known inks, such as spot color inks, e.g., a light color ink like a light cyan ink, and an orange ink, can also be used in combination. The sheet S with ink applied thereon is turned at the winding guide rollers R1 in the lower direction of the recording apparatus 1. Thereafter, the sheet S is heated and dried by the second drying unit 40b in the second conveyance path 8b, so that the ink is fixed to the sheet S. The contact roller R3 for forming a sheet conveyance path is arranged in the SD8b direction of the second conveyance path 8b. The surface of the sheet S with ink applied thereon comes into contact with the surface of the contact roller R3. To keep the surface layer of the sheet S with ink applied thereon in a good condition, the ink is desirably solidified before the sheet S reaches the contact roller R3. In the present exemplary embodiment, the second cooling unit 50b is arranged downstream of the second drying unit 40b in the second conveyance path 8b, so that the ink is solidified before the sheet S reaches the contact roller R3.

### <Control of Ink Jet Recording Apparatus>

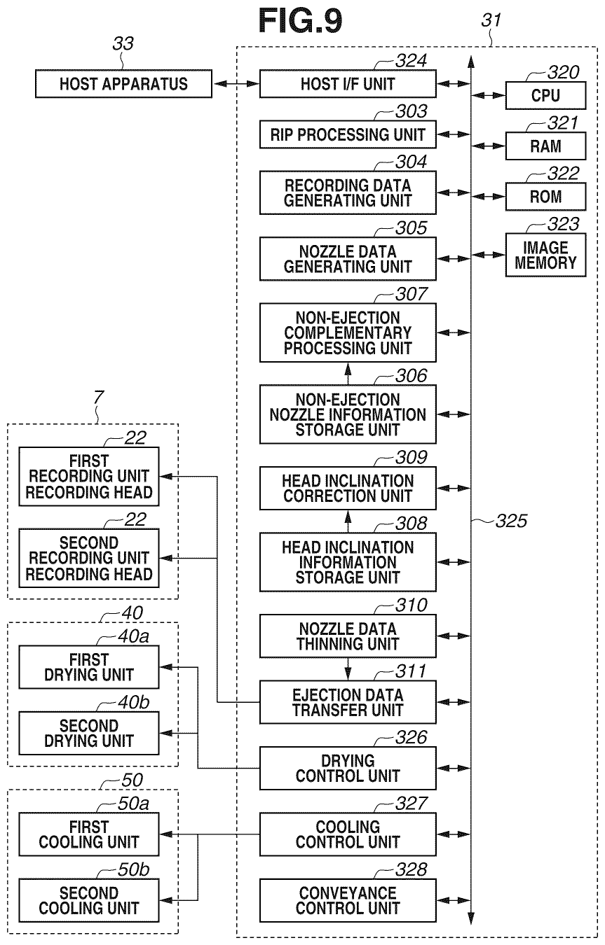

The control unit 31 for performing data flow processing of the recording apparatus 1 according to the present exemplary embodiment will now be described with reference to FIG. 9. The control unit 31 includes a host interface (I/F) unit 324. Print data received from the host apparatus 33 is rendered into multivalued bitmap data by a raster image processor (RIP) processing unit 303 via the host I/F unit 324. The received print data is described in page description language (PDL). A recording data generation unit 304 performs ink color conversion processing and quantization processing on the multivalued bitmap data, so that the multivalued bitmap data is processed into halftone data of the respective ink colors. A nozzle data generation unit 305 assigns the halftone data to nozzles of each color as nozzle data (binary data) for each line according to the number of nozzles. A non-ejection complementary processing unit 307 performs non-ejection complementary processing on the nozzle data according to the non-ejection nozzle information stored in a non-ejection nozzle information storage unit 306. This processing reallocates the ejection data assigned to the non-ejection nozzles to the active nozzles. Based on head inclination information stored in a head inclination information storage unit 308, a head inclination correction unit 309 executes head inclination correction (i.e., correction to move the data in the conveyance direction according to the amount of inclination) on the nozzle data subjected to the non-ejection complementary processing. The nozzle data corrected by the head inclination correction is stored in an image memory 323.

A CPU 320 transmits the nozzle data stored in the image memory 323 to a nozzle data thinning unit 310. The nozzle data thinning unit 310 performs thinning processing on the transmitted nozzle data corrected by the head inclination correction. Thereafter, an ejection data transfer unit 311 transfers the nozzle data to the respective recording heads 22 included in the first recording unit 7a and the second recording unit 7b. Further, the CPU 320 includes one or more processers and performs control of the above-described units. This control is performed based on control programs stored in a read-only memory (ROM) 322. The control programs stored in the ROM 322 includes an operating system (OS) that executes time-division control using a system clock in units of a load module called a task. A random-access memory (RAM) 321 is used as a working area of the CPU 320. The units including the CPU 320 are connected to a system bus 325.

The control unit 31 includes a drying control unit 326, a cooling control unit 327, and a conveyance control unit 328. The drying control unit 326 controls the temperatures of the first drying unit 40a and the second drying unit 40b, and performs driving control of the blowing devices 432. The cooling control unit 327 controls the cooling operations performed by the first cooling unit 50a and the second cooling unit 50b. The conveyance control unit 328 controls the conveyance units between the unwinding roll unit 2 and the winding roll unit 14 to convey the sheet S at a predetermined conveyance speed. Specifically, the conveyance units refer to the unwinding roll unit 2, the first dancer-roller unit 3, the first main conveyance unit 4, the meandering correction unit 5, the conveyance detection unit 6, the conveyance tension detection unit 9, the second main conveyance unit 12, the second dancer-roller unit 13, and the winding roll unit 14. When print data is received from the host apparatus 33, a driving table is applied to the drying control unit 326, the cooling control unit 327, and the conveyance control unit 328 based on the print data. Predetermined values based on the recording condition, such as a type of image data and a type of recording medium, and values input by the user via the operation unit 32 are registered in the driving tables. By executing control based on the recording condition, desirable recording processing can be performed depending on image data, a recording medium, and a desired productivity.

### <Configuration of Drying/Cooling Unit>

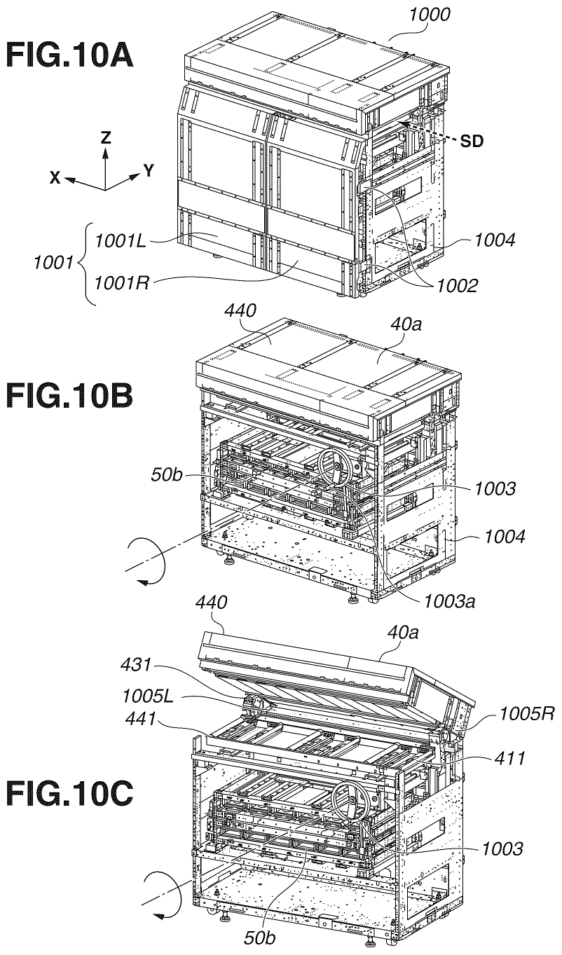

A region surrounded by a dotted line in FIG. 1, i.e., a drying/cooling unit 1000, will be described with reference to FIGS. 10A to 10C. FIG. 10A is a perspective view of the drying/cooling unit 1000 on which exterior parts are arranged. FIG. 10B is a perspective view of the drying/cooling unit 1000 from which access doors 1001 arranged on the front (−Y direction) of the recording apparatus 1 is removed. FIG. 10C is a perspective view of the drying/cooling unit 1000 when the first drying unit 40a is opened in a direction away from the sheet supporting rollers 411.

In FIG. 10A, the access doors 1001 pivot around hinges 1002 arranged upstream and downstream (the left and right ends of the drying/cooling unit 1000) in the conveyance direction with respect to a frame 1004. Access doors 1001L and 1001R are opened by pivoting from the center to the left and right (not illustrated). Opening the access doors 1001 in a so-called double door style makes it easier to perform maintenance, such as cleaning or replacing parts of the second cooling unit 50b inside the drying/cooling unit 1000.

A handle 1003, which is seen when the access doors 1001 are being opened, corresponding to a driving input unit is arranged in the front of the recording apparatus 1. As illustrated in FIG. 10B, a grip 1003a is mounted on the handle 1003. The first drying unit 40a is placed on the uppermost portion of the frame 1004 consisting of a plurality of columnar and beam-shaped sheet metal parts.

A method of opening and closing the first drying unit 40a will be described with reference to FIG. 10C. The user rotates the handle 1003 clockwise around its axis. Through the driving unit described below, the access cover 440 is opened from the front to the rear of the recording device 1 with hinges 1005L and 1005R, which are rotatably supported at the rear of the recording device 1 with respect to the frame 1004. In other words, the access cover 440 is designed to open by moving one side while the other side serves as a fulcrum. In an opening region, the airflow ducts 431 illustrated in FIG. 4A are arranged on the access cover 440, and six sheet supporting rollers 411 and a tray portion 441 are arranged on the frame 1004 opposite to the access cover 440. The tray portion 441 supports the six sheet supporting rollers 411, and covers and shields the airflow space 430 in FIG. 4A. When the access cover 440 is closed, the tray portion 441 serving as a cover member is arranged at a position opposite to one side of the access cover 440 located on the conveyance path.

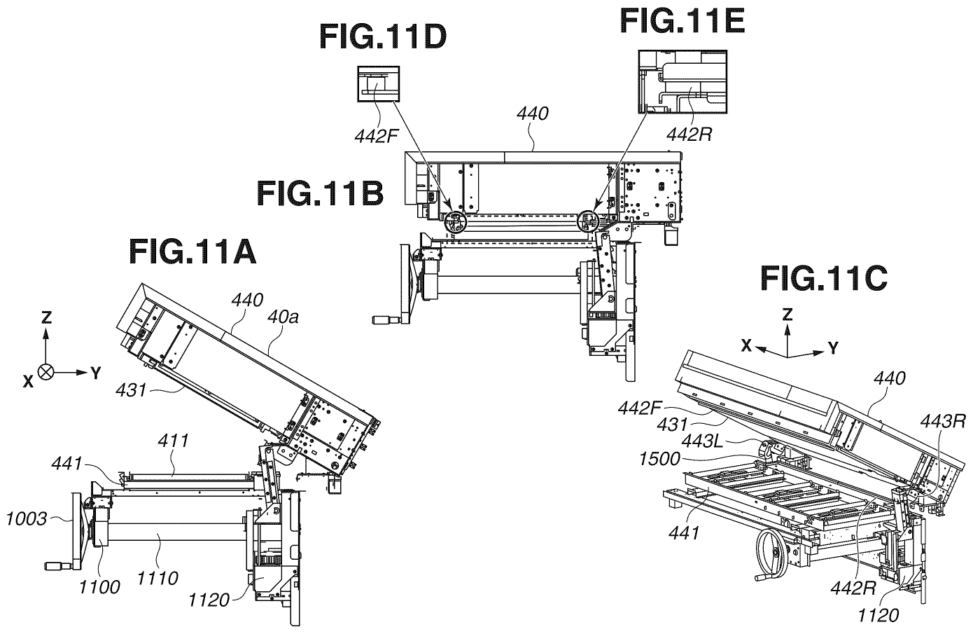

The above-described airflow ducts 431 and a method for shielding the airflow space 430 using the tray portion 441 will be described with reference to FIGS. 11A to 11E. FIG. 11A is a perspective view of the first drying unit 40a with the access cover 440 opened at an angle of 30 degrees, viewed in the sheet conveyance direction. FIG. 11B is a perspective view of the first drying unit 40a while the access cover 440 is in a closed state, viewed in the sheet conveyance direction. FIG. 11C is a perspective view of the first drying unit 40a in a state illustrated in FIG. 11A, viewed from the front of the recording apparatus 1. FIGS. 11D and 11E are partially enlarged diagrams of the first drying unit 40a illustrated in FIG. 11B.

In FIG. 11C, a sealing member 442F is arranged on the access cover 440, and a sealing member 442R is arranged on the tray portion 441. The sealing members 442F and 442R are elastic members made of ethylene propylene diene monomer (EPDM) rubber. When the access cover 440 is closed as illustrated in FIG. 11B, the sealing members 442F and 442R are compressed between the access cover 440 and the tray portion 441 to maintain the sealing performance of the access cover 440 and the tray portion 441. In this manner, warm air (e.g., air having a temperature greater than 50° C.) flowing out of the airflow ducts 431 is sealed within a region indicated by a dotted line in FIG. 11B except for an entrance and an exit in the conveyance direction of the sheet S. At a position below the dotted-lined region, the recording apparatus 1 includes a first driving unit 1100. The first driving unit 1100 is arranged on one side of the handle 1003 which faces the rear of the recording apparatus 1 on the opposite side in the sheet width direction (i.e., the Y direction). The recording apparatus 1 further includes a second driving unit 1110 and a third driving unit 1120. The second driving unit 1110 is arranged inside the frame 1004 and extends from the front to the rear of the recording apparatus 1, and the third driving unit 1120 is arranged on the rear of the recording apparatus 1. The first to the third driving units 1100, 1110, and 1120 are arranged in a region outside the dotted-lined region in FIG. 11B. These driving units reduce as much as possible fluctuation of transmission torque caused by the impact of expansion of constituent elements with heat of air out of the airflow ducts 431 on the drive transmission accuracy of the gears. The third driving unit 1120 is arranged on the rear of the recording apparatus 1 instead of being arranging on the front of the recording apparatus 1. This is because moving members included in the third driving unit 1120 on the front of the recording apparatus, which will be described below, reduce user's convenience for maintenance of the conveyance unit when the user moves and opens the access cover 440 while supporting the access cover 440.

In the present exemplary embodiment, the upper unit can be opened and closed with respect to the conveyance path in each unit. In other words, the upper unit can be opened and closed with respect to the lower units. Further, the upper unit can be opened and closed with respect to a single lower unit, as well as a plurality of lower units. Specifically, a single access cover is disposed to cover a plurality of lower units, so that the user can access to the plurality of lower units by opening/closing the access cover.

### (Configuration of Units for Opening and Closing Access Cover 440)

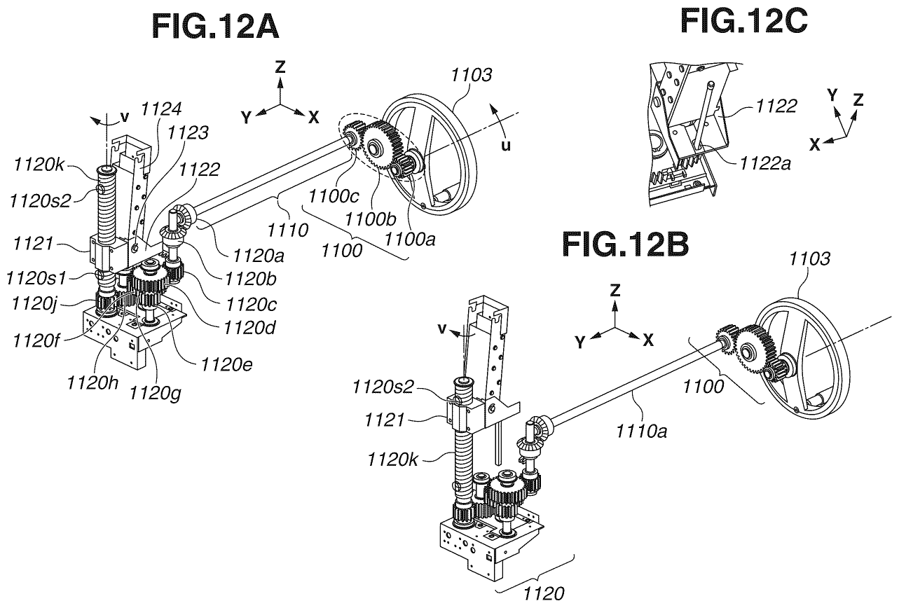

The first to the third driving units 1100, 1110, and 1120 serving as the opening and closing units of the access cover 440 will be described in detail. FIGS. 12A to 12C are diagrams illustrating perspective views of a driving configuration of a moving member 1124 for directly moving the access cover 440, the moving member 1124 of which acts in the opening/closing directions of the access cover 440 by driving force from the handle 1003. FIG. 12A is a diagram illustrating a perspective view of the driving configuration when the access cover 440 is closed. For the sake of simplicity, a frame for supporting gears is not illustrated in FIGS. 12A to 12C. FIG. 12B is a diagram illustrating a perspective view of the driving configuration when the access cover 440 is opened at an angle of 30 degrees. The moving member 1124 is arranged on one side of the sheet width direction orthogonal to the conveyance direction of the recording medium. The moving member 1124 is arranged on the side of the conveyance direction of the recording medium opposite to the side where the access cover 440 is opened.

Movement of the moving member 1124 in the substantially up-down direction of the recording apparatus 1 when the user manually operates the handle 1003 will be described with reference to FIG. 12A. When the handle 1003 is rotated about the rotation center in a direction indicated by an arrow u, driving force is transmitted to gears 1100a to 1100c included in the first driving unit 1100. Then, the driving force is further transmitted to the third driving unit 1120 located on the rear of the recording apparatus 1 via a driving shaft 1110a included in the second driving unit 1110.

Specifically, driving force is transmitted to the third driving unit 1120 from the second driving unit 1110 as follows. Driving force is input to a bevel gear 1120a, and the axis direction of the driving force is transformed by a bevel gear 1120b. Then, the driving force is transmitted to a spur gear 1120c, stepped gears 1120d and 1120e, subsequent stepped gears 1120f and 1120g, and spur gears 1120h and 1120j. A thread portion 1120k is arranged coaxially with the spur gear 1120j. The thread portion 1120k is a right-hand external thread. The thread portion 1120k rotates in a direction indicated by an arrow v when the handle 1003 is rotated in the direction indicated by the arrow u. A member 1121 which engages with the thread portion 1120k has a thread portion at a central part thereof. Thus, the member 1121 is moved in a direction parallel to the axis direction of the thread portion 1120k in tandem with the rotation of the thread portion 1120k.

Stopper pins 1120s1 and 1120s2 are arranged in a direction orthogonal to the axis direction of the thread portion 1120k, and limit the moving range of the member 1121 to be moved in tandem with the movement of the thread portion 1120k. In FIG. 12B, in tandem with the rotation of the thread portion 1120k, the member 1121 is moved in the +Z direction to abut on the stopper pin 1120s2. A bracket 1122 is fixed to the member 1121 with not-illustrated positioning members and screws. FIG. 12C is an enlarged view of the bracket 1122 fixed to the member 1121. A hole 1122a is formed in the bracket 1122. A guide shaft 1125 mounted on the third driving unit 1120 passes through the hole 1122a, preventing the member 1121 from being moved in a rotation direction in tandem with the movement of the thread portion 1120k. The bracket 1122 has a shaft 1123, and the moving member 1124 is rotationally arranged thereon.

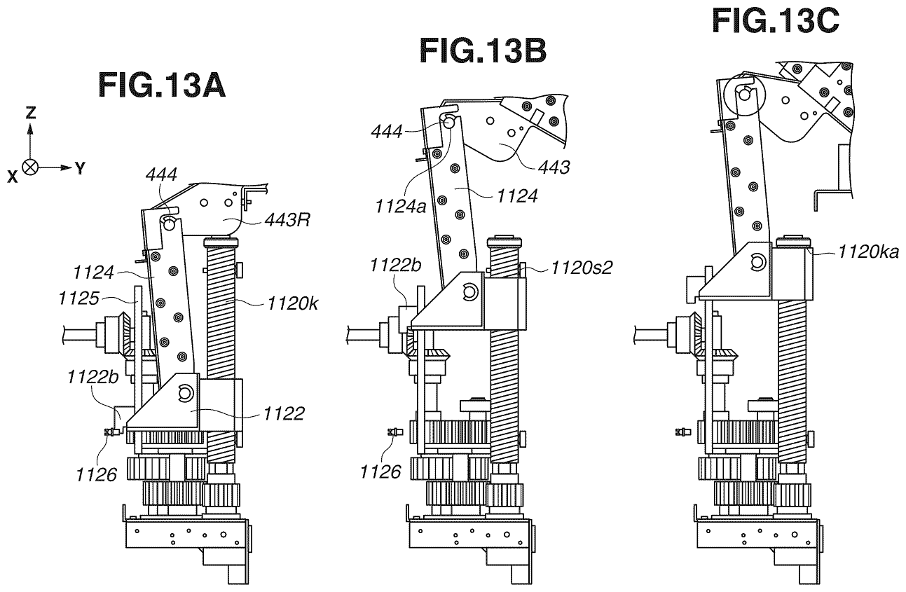

FIG. 13A is a partial side view of the third driving unit 1120 viewed in the sheet conveyance direction. FIGS. 13A, 13B, and 13C are partial side views of the third driving unit 1120 when the access cover 440 is closed, when the access cover 440 is opened at an angle of 30 degrees, and when the access cover 440 is opened at an angle of 40 degrees, respectively.

In FIG. 13A, a flag portion 1122b is arranged on the front of the bracket 1122 of the recording apparatus 1, and shields a photo-interrupter 1126 fixed to a part of a not-illustrated frame of the third driving unit 1120 from light. The photo-interrupter 1126 as a detection unit can detect whether the access cover 440 is closed at a desired position.

As described above, when the handle 1003 is operated as illustrated in FIG. 12A, the moving member 1124 is brought into a state illustrated in FIG. 13B from a state illustrated in FIG. 13A. At this time, the flag portion 1122b is separated from the photo-interrupter 1126, so that the photo-interrupter 1126 is brought into a light-transmission state. A link shaft 444 on a leading end of an arm 443R provided on the access cover 440 is received by a U-shape portion 1124a formed on the upper part of the moving member 1124. Thus, the access cover 440 is opened in tandem with the upward movement of the moving member 1124.

FIG. 13C is a partial side view of the third driving unit 1120 when the user opens the access cover 440 at an angle of 40 degrees in order to replace a gas spring 1500 described below. As described above, since the member 1121 abuts on the stopper pin 1120s2 arranged on the thread portion 1120k, an opening angle of the access cover 440 is restricted to a predetermined angle. When the user removes the stopper pin 1120s2 and further opens the access cover 440, the moving member 1124 can be moved to an end portion 1120ka of the thread portion 1120k. With this configuration, the user can increase the opening angle (a second angular range) wider than that (a first angular range) used to perform normal cleaning without performing excessive operation in maintenance of the recording apparatus 1.

In the present exemplary embodiment, a trapezoidal thread having a nominal diameter of 32 mm is used for the thread portion 1120k. The trapezoidal thread can be used for the access cover 440 having a heavy weight (approximately 80 kilogram (kg) to 100 kg) in order to reduce friction on the thread portion. The screw part 1120k is set so that a friction angle tan β, calculated from the load acting on the screw's inclined surface and the friction coefficient, is larger than a lead angle tan θ, which is calculated from an effective diameter ad (d nominal diameter) of the screw and the lead L, meaning the distance of a screw advance in the axial direction per one rotation. Thus, the thread portion 1120k has a so-called self-locking function, which can prevent the opened access cover 440 from being closed once it has been opened. The self-locking function unmovable in the closing direction can hold the access cover 440 at a desired opening angle without holding the handle 1003 by the user. In the present exemplary embodiment, a trapezoidal thread is used as a locking unit. However, another mechanism can also be used. For example, a similar self-locking function can be provided by making the axial directions of the spur gear 1120h and the spur gear 1120j perpendicular to each other and using the spur gears 1120h as a worm gear and 1120j a worm wheel in FIG. 12A.

### (Control for Detecting Opened/Closed States of Access Cover 440)

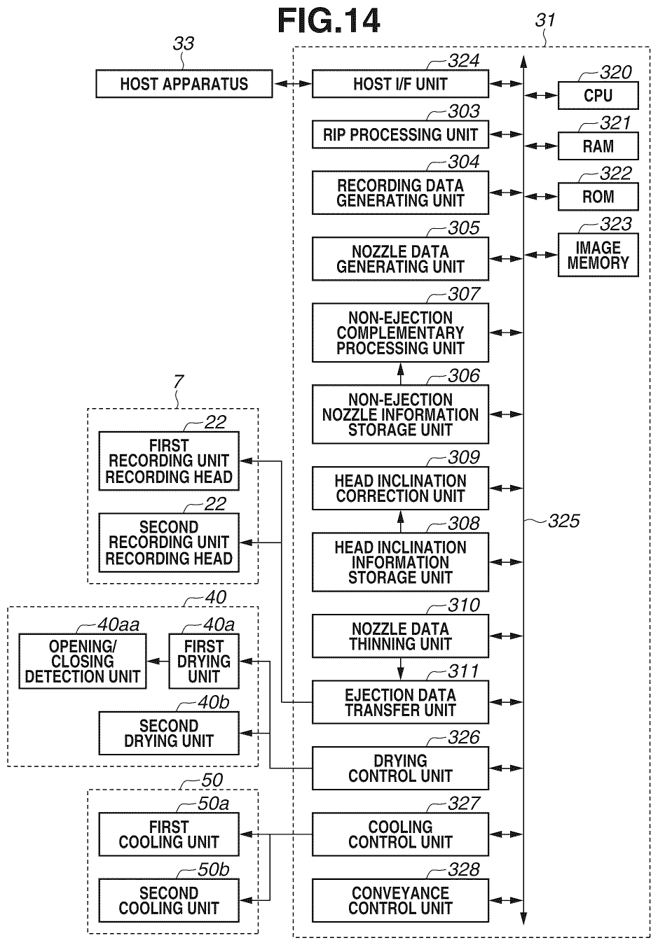

Detection of the opened/closed states of the access cover 440 illustrated in FIGS. 13A to 13C will be described with reference to FIG. 14. In the following description, the control of the recording apparatus 1 is the same as that described in FIG. 9, so that the block diagram illustrated in FIG. 9 will be referenced accordingly and similar configurations to those of FIG. 9 will be omitted as appropriate. An opening/closing detection unit 40aa is placed under the hierarchy of the drying control unit 326 and the first drying unit 40a subordinate to the drying control unit 326. In a state where the photo-interrupter 1126 is in a light-blocked state, or the access cover 440 remains closed, the control unit 31 performs control of starting a recording operation via the drying control unit 326 and the CPU 320. This control can ensure that, for example, if the access cover 440 is not fully closed, the first drying unit 40a will not operate, which prevents the sheet S from moving to the second recording unit with the W ink not fully solidified.

### (Elastic Unit for Supporting Access Cover)

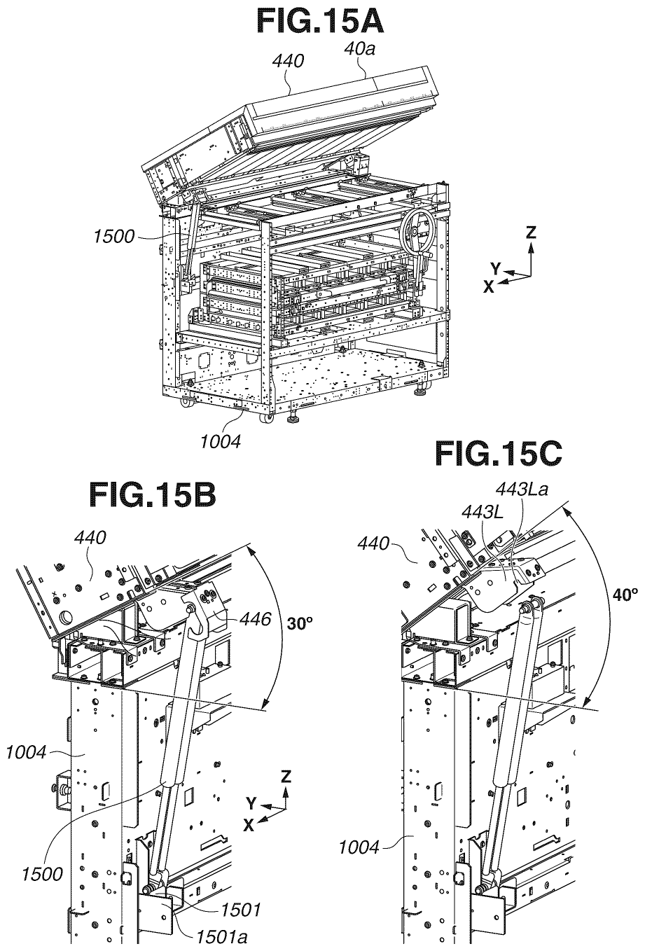

In addition to the movement configuration using the first to the third driving units 1100, 1110, and 1120 for the access cover 440, a configuration using an auxiliary elastic member will be described with reference to FIGS. 15A to 15C. FIG. 15A is a perspective view of the drying/cooling unit 1000 in the state illustrated in FIG. 10C, viewed from downstream at the side opposed to the conveyance direction. Two gas springs are arranged in parallel downstream of the access cover 440 in the conveyance direction. FIG. 15B is an enlarged view of gas springs 1500 provided on the opened access cover 440 and the frame 1004 downstream of the first drying unit 40a in the conveyance direction. The gas springs 1500 act in a direction against the own weight of the access cover 440 to reduce force used to operate the grip 1003a. The gas springs 1500 are arranged so that the gravity center of the access cover 440 is positioned substantially halfway between the gas springs 1500 and the third driving unit 1120 in the conveyance direction. This configuration can prevent the access cover 440 from becoming distorted considerably when the access cover 440 is opened.

As illustrated in FIG. 15B, the two gas springs 1500 are arranged in parallel in the conveyance direction and each supported by a recess portion 1501a of a supporting member 1501 attached to a lower portion of the frame 1004 on the front of the recording apparatus 1. The gas springs 1500 are supported by the supporting member 1501 and an arm 443L corresponding to the arm 443R. The arm 443L has a U-shape portion 443La which engages with one gas spring 1500. FIG. 15C is a partially enlarged diagram of a portion including the gas spring 1500 when the opening angle is 40 degrees. When the state illustrated in FIG. 15B (a state where the opening angle is 30 degrees) is changed to the state illustrated in FIG. 15C, the access cover 440 opens wider than the natural length of the gas spring 1500. As a result, the engagement of the U-shape portion 443La and the gas spring 1500 is released as illustrated in FIG. 15C. This configuration allows the user to easily replace a gas spring 1500 after removing a holding member 446 illustrated in FIG. 15B.

### <Configuration of Driving Input Unit>

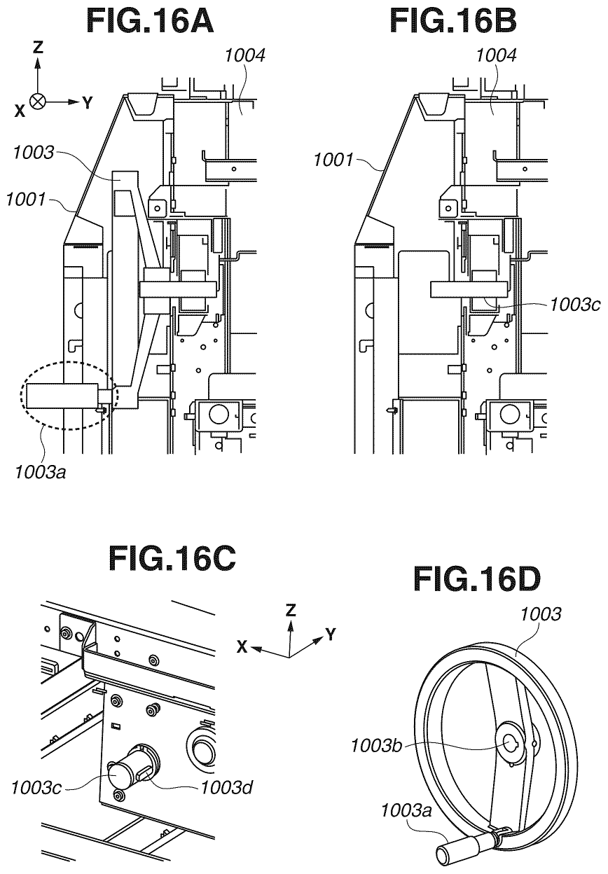

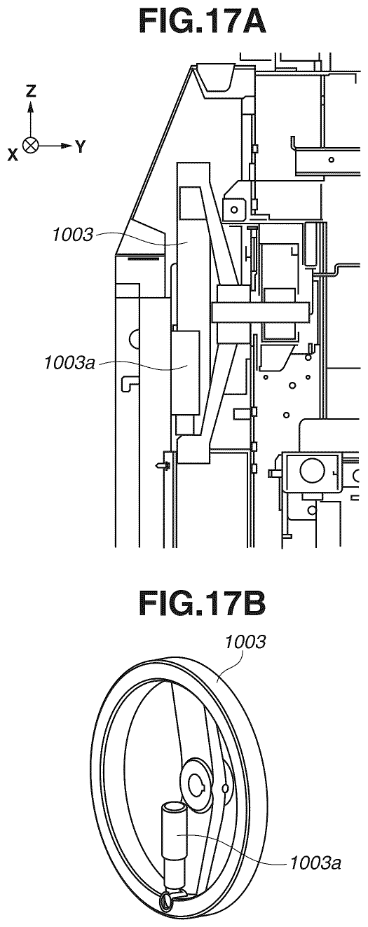

A relationship between the handle 1003 serving as a driving input unit and the access doors 1001 illustrated in FIG. 10A will be described with reference to FIGS. 16A to 16D and FIGS. 17A and 17B. FIG. 16A is a partial cross-sectional view of the vicinity of the handle 1003, viewed from upstream in the conveyance direction of the recording apparatus 1. When the access door 1001R is closed while the handle 1003 remains operable by the user, a portion indicated by a dotted line in FIG. 16A interferes with the grip 1003a. On the other hand, FIG. 16B illustrates a state where the access door 1001R is closed after removing the detachable handle 1003 from a driving input shaft 1003c. Making the handle 1003 detachable can prevent interfere between the handle 1003 and other components, such as the grip 1003a. FIG. 16C is a partially enlarged view of FIG. 16B. The driving input shaft 1003c has a key-shape portion 1003d. The key portion 1003d engages with a key groove 1003b provided in a hole at the center of the handle 1003 illustrated in FIG. 16D. With the driving input shaft 1003c fitted into the hole, force applied by a user's operation is transmitted as driving force.

FIG. 17A illustrates a configuration different from the configuration illustrated in FIG. 16B, which can prevent interference between the handle 1003 and other components. Specifically, FIG. 17A illustrates a configuration where the orientation of the grip 1003a is changed with respect to the handle 1003 when the access door 1001R is closed. In other words, the handle 1003 has a first form for user operation and a second form for other situations. FIG. 17B is a perspective diagram illustrating a state where the grip 1003a is tilted substantially at a right angle with respect to the axial direction of the handle 1003, corresponding to the second form.

As described above, making the handle 1003 detachable, and the relative position of the handle 1003 and the grip 1003a adjustable can improve usability and reduce the size of the recording apparatus 1.

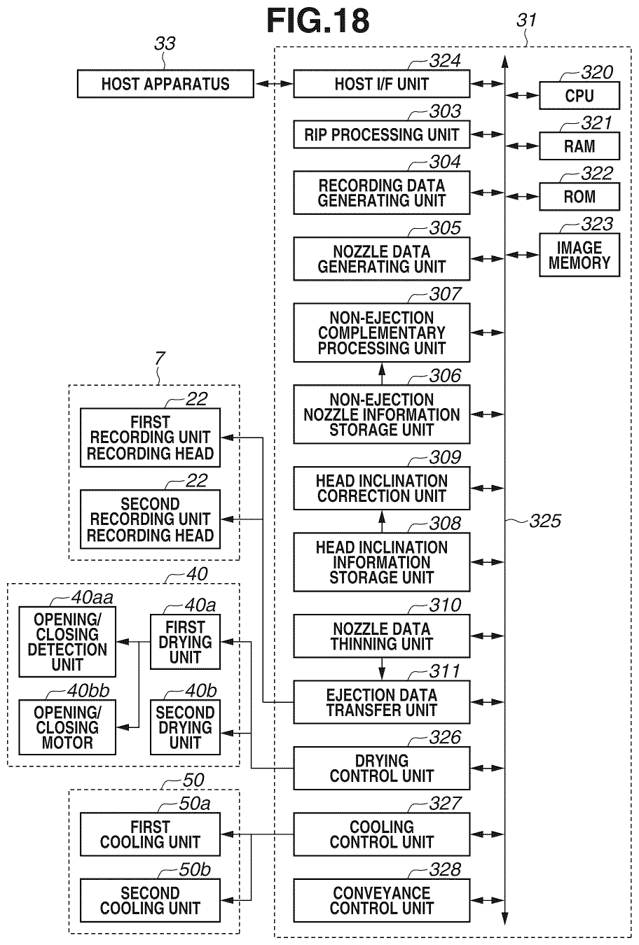

In the present exemplary embodiment, the handle 1003 is manually operated by the user. Here, a driving source is not limited to the above-described configuration, and can be a motor. In this case, a driving input unit transmits a driving force of a not-illustrated motor to a transmission unit. FIG. 18 is a block diagram of a driving system using a motor. In the following description, the control of the recording apparatus 1 is the same as that described in FIG. 14, so that the block diagram illustrated in FIG. 14 will be referenced accordingly and similar configurations to those of FIG. 14 will be omitted as appropriate. An opening/closing detection unit 40ab is placed under the hierarchy of the drying control unit 326 and the first drying unit 40a subordinate to the drying control unit 326. From a state where the access cover 440 is closed, the CPU 320 causes the opening/closing motor 40ab to drive for a desired number of steps or a desired period of time to open the access cover 440 at a desired opening angle using the opening/closing detection unit 40aa.

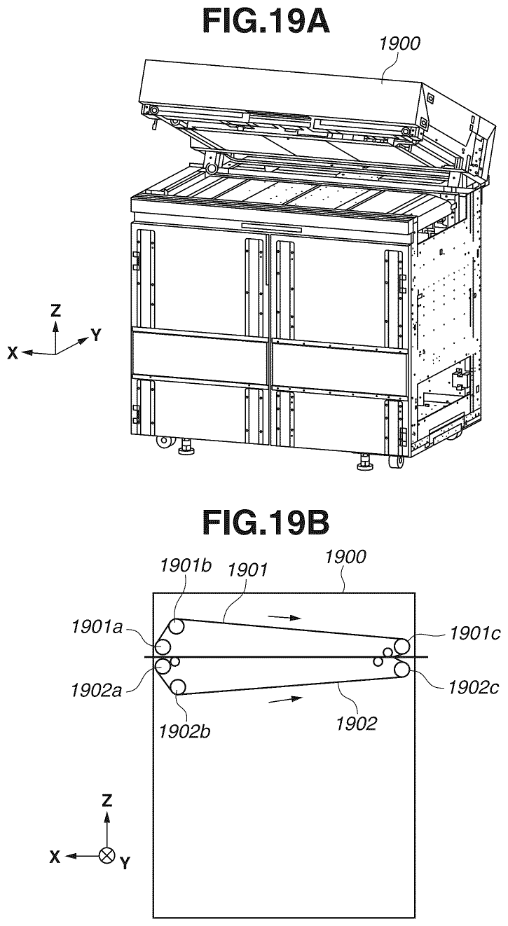

In the present exemplary embodiment, the configuration for opening and closing the first drying unit 40a has been described. However, the configuration according to the exemplary embodiment of the present disclosure can similarly be applied to the first cooling unit 50a for cooling a recording medium. The configuration according to the exemplary embodiment of the present disclosure can be applied to a fixing apparatus illustrated in FIGS. 19A and 19B. In other words, the entire unit can be a drying unit, such as the first drying unit 40a, which includes a heating unit for drying ink. Further, the entire unit can be a cooling unit, such as the first cooling unit 50a, which includes a cooling unit for cooling a recording medium, or can be a fixing unit which includes a fixing unit for fixing ink. Thus, units that act on a recording medium include a unit for forming an image on a recording medium, such as the drying unit, the cooling unit, and the fixing unit, and may be referred to as an “action unit” or “action units”. The above-described main conveyance unit and a dancer-roller unit for adjusting tension of a recording medium are also included in the action units that act on a recording medium.

FIG. 19A is a perspective view of a fixing apparatus 1900 including two pairs of belts. The fixing apparatus 1900 nips both the surfaces of the recording medium using the belts to solidify and fix ink to a recording medium. FIG. 19B is a schematic diagram illustrating a configuration of the fixing apparatus 1900. The fixing apparatus 1900 includes a belt unit 1901 at the upper part of the fixing apparatus 1900, and a belt unit 1902 symmetrically arranged at the lower part of the fixing apparatus 1900. The belts included in the belt units 1901 and 1902 are each made of a deformable material, and respectively stretched around rollers 1901a to 1901c and rollers 1902a to 1902c. At the belt units 1901 and 1902, the rollers 1901a and 1902a are driving rollers, and conveys the belts in directions indicated by arrows in FIG. 19B. Further, the rollers 1901b, 1901c, 1902b, and 1902c are heating rollers having heating units, and can heat the belts to approximately 50° C. to 100° C. A halogen heater can be used as the above-described heating unit. In this configuration, the conveyance unit is desirably opened as illustrated in FIG. 19A when clearance of a jammed recording medium and cleaning of the conveyance unit are performed. Thus, the exemplary embodiment of the present disclosure can similarly be applied thereto.

A second exemplary embodiment will now be described, and the description of the configuration similar to that described in the above-described exemplary embodiment will be omitted. In the present exemplary embodiment, the opened/closed state of the first drying unit 40a can be ensured based on a relationship between the photo-interrupter 1126 and the flag portion 1122b, as well as tolerances of mechanical components.

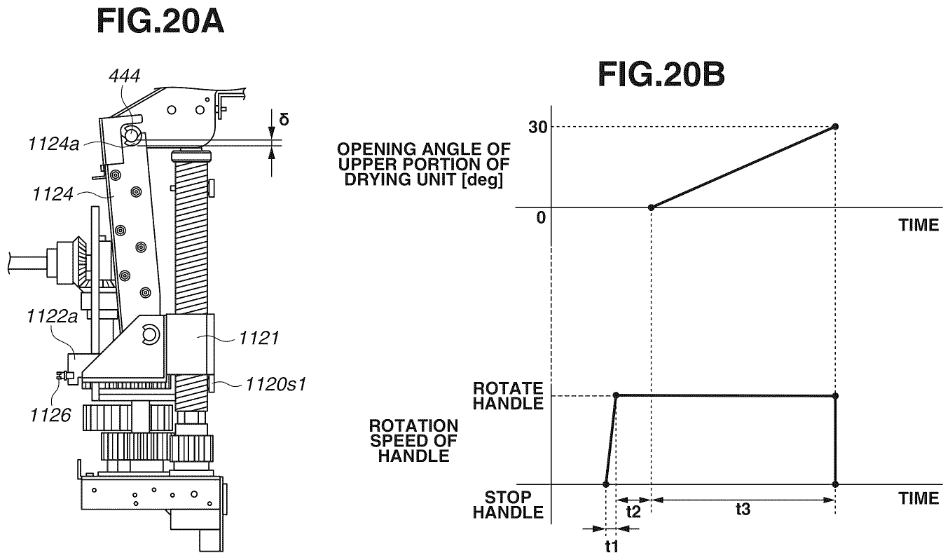

FIG. 20A is a diagram illustrating a mechanism for opening and closing the access cover and an opening angle of the access cover according to the present exemplary embodiment. The access cover 440 is not determined to be fully closed at the time when the flag portion 1122b shields the photo-interrupter 1126 as illustrated in FIG. 13A. The access cover 440 is determined to be fully closed when the link shaft 444 is separated from the U-shape portion 1124a, and the moving member 1124 is driven up to a position where the moving member 1124 does not act on the link shaft 444. Specifically, from a point when the flag portion 1122b shields the photo-interrupter 1126, the handle 1003 is further driven continuously. As a result, the member 1121 is moved by the thread portion 1120k until the member 1121 comes into contact with the stopper pin 1120s1 located on the lower part of the recording apparatus 1. When the member 1121 abuts on the stopper pin 1120s1, the driving input unit receives resistance. Thus, the user stops operating the handle 1003. As the member 1121 stops, the movement of the moving member 1124 also stops. Further, the access cover 440 abuts on an abutting portion (not illustrated) of the frame 1004, so that the access cover 440 is fully closed with respect to the frame 1004. As a result, a gap δ is formed between the link shaft 444 and the U-shape portion 1124a as illustrated in FIG. 20A, so that the moving member 1124 does not act on the access cover 440. This gap δ can be set in consideration of gaps present with a driving unit and other components.

FIG. 20B is a graph illustrating a relationship between a rotation speed of the handle 1003 and an opening angle of the access cover 440. A horizontal axis represents time. For the sake of simplicity, a rotation speed of the handle 1003, illustrated in a lower part of the graph, is constant except for a rotation speed in a rising section t1. As illustrated in the lower part of the graph, from the fully closed state of the access cover 440, the rotation speed of the handle 1003 becomes constant after the rising section t1. Then, in a section t2, the member 1121 is moved upward in the recording apparatus 1, transitioning from the state illustrated in FIG. 20A to the state illustrated in FIG. 13A. In a section t3, the moving member 1124 acts on the link shaft 444 to start to open the access cover 440, and then the opening angle reaches 30 degrees (a state in FIG. 13B). In other words, the t3 time taken to move the access cover 440 from the closed state the open state is shorter than the time to drive the handle 1003 (t1+t2+t3). This configuration can ensure that the access cover 440 is closed with respect to the frame 1004 considering tolerances the driving components and parts while maintaining usability and reduce the size of the apparatus. In other word, hot air can be prevented from leaking through gaps and the gaps in the appearance of the recording device 1 are not excessively large. Further, “time spent for driving the handle 1003” means “time spent for inputting the driving force to the driving input unit”.

While a third exemplary embodiment will now be described, the description of the configuration similar to that described in the above-described exemplary embodiments will be omitted. In the present exemplary embodiment, ink tanks serving as an ink containing unit are arranged on the upper part of the first drying unit 40a. The orientations of the ink tanks are changed when the access cover 440 is opened/closed.

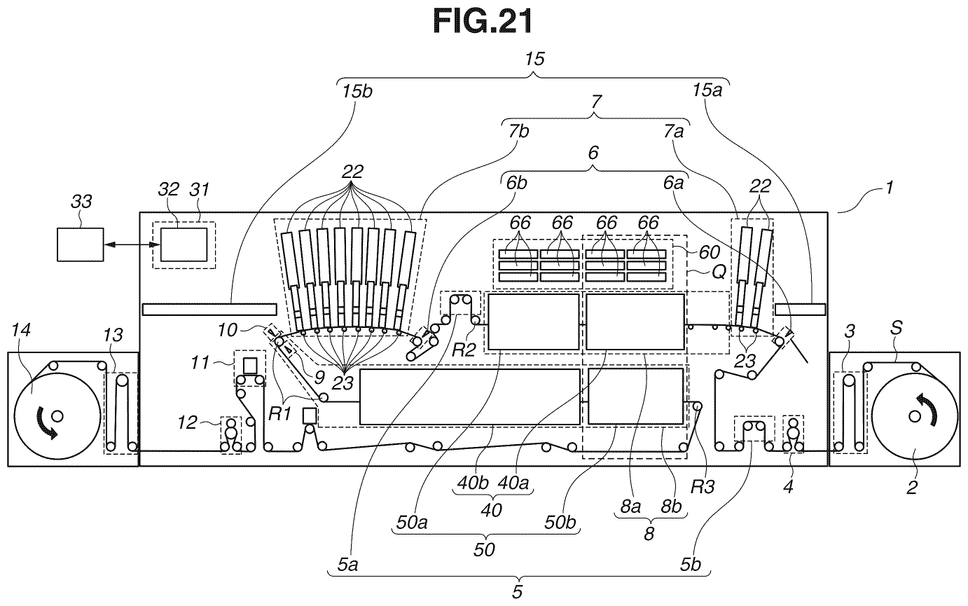

As illustrated in FIG. 21, an ink tank unit 60 accommodating twelve ink tanks 66 is arranged above the first drying unit 40a and the first cooling unit 50a. The twelve ink tanks 66 store a reaction liquid and three spot-color inks, as well as white (W), black (Bk), yellow (Y), and magenta (M). Herein, one type of color ink does not always have to be stored in one ink tank 66. For example, the reaction liquid and the black (Bk) ink may be each stored in two ink tanks 66.

A not-illustrated ink supply path can be shorter by arranging the ink tank unit 60 between the first recording unit 7a and the second recording unit 7b as illustrated in FIG. 21. Further, the user can replenish ink at a single location at the substantially center of the recording apparatus 1 in the conveyance direction. On the other hand, focusing on the area indicated by dashed lines Q in FIG. 21, six ink tanks 66 are stacked on the first drying unit 40a, and the weight will increase by approximately 50 kg to 100 kg including non-illustrated housings and ink supply units. Furthermore, due to the operation of the recording apparatus 1, an amount of ink stored in the ink tank 66 varies. Thus, it is difficult to keep the force (operation force) applied by the user to open and close the access cover 440 within a predetermined range. However, the above issue can be resolved with the configuration according to the present disclosure. The reason for this will be described in the following.

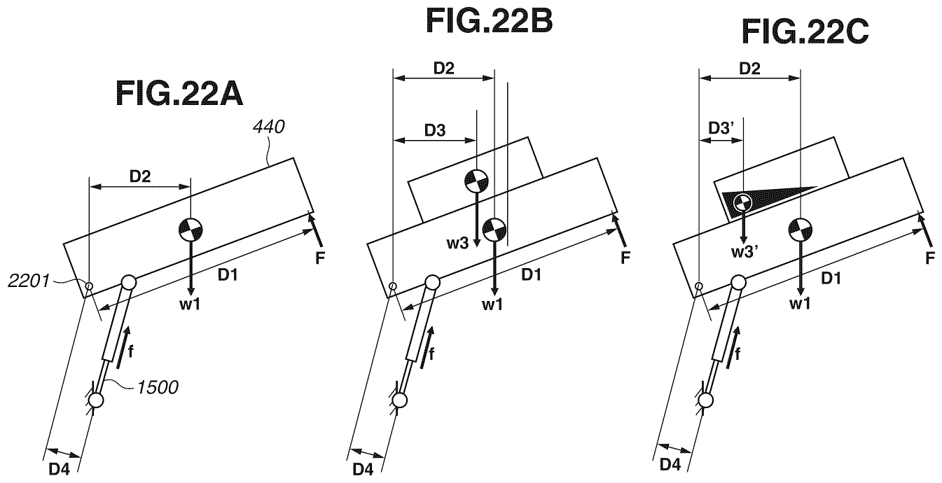

FIGS. 22A to 22C are schematic diagrams each illustrating a relationship between moments acting on the access cover 440 and the elastic member. FIG. 22A illustrates a state where nothing is stacked on the access cover 440, assuming the first exemplary embodiment, and FIG. 22B illustrates a state an ink tank 66 with ink full or empty therein. FIG. 22C illustrates a state where ink in the ink tank 66 does not remail full but stores a certain amount, so that ink (a black portion) is moved when the access cover 440 is opened. For the sake of simplicity, a single ink tank 66 is illustrated.

In FIG. 22A, when a distance between a rotation center 2201 of the access cover 440 and the gravity center of the access cover 440 is D2, the weight of the access cover is w1, a distance between the rotation center 2201 of the access cover 440 and an operation unit of the access cover 440 is D1, a force (operation force) used for retaining the orientation is F, the number of gas springs 1500 is n, an elastic force of the gas spring 1500 is f, and a distance between the rotation center 2201 of the access cover 440 and the gas spring 1500 is D4, an operation force F1 will be described by the following formula.

F1=(w1×D2−n×f×D4)/D1

In FIG. 22B, when a weight of the ink tank 66 including a weight of ink is w3, and a distance between the rotation center 2201 of the access cover 440 and the gravity center position of the ink tank 66 is D3, an operation force F2 in FIG. 22B will be described by the following formula.

F2=(w1×D2+w3×D3−n×f×D4)/D1

Then, in FIG. 22C, when a weight of the ink tank 66 including a weight of ink is w3′, and a distance between the rotation center 2201 of the access cover 440 and a combined gravity center position of ink and components of the ink tank 66 is D3′, an operation force F3 in FIG. 22C will be described by the following formula.

F3=(w1×D2+w3′×D3′−n×f×D4)/D1

Herein, because of the amount of ink remaining in the ink tank 66, the value of the operation force F3 tends to fluctuate much more than that of the operation force F1.

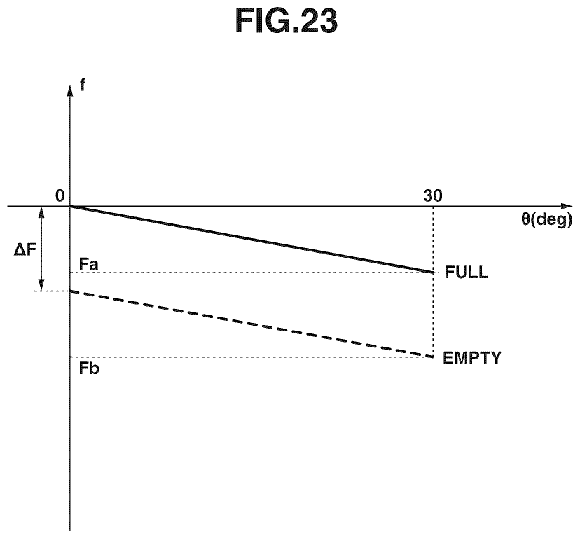

FIG. 23 is a graph illustrating a relationship between an opening angle of the access cover 440 and an operation force F applied by the user to close the access cover 440. A vertical axis represents the operation force used to close the access cover 440, and the operation force becomes greater toward the lower part of the graph. In FIG. 23, the operation force is illustrated in a negative region because this operation force acts in the direction opposite to a direction of the operation force illustrated in FIGS. 22A to 22C. As indicated by a solid line in FIG. 23, in a state where the ink tank 66 is full of ink, the operation force acting on the access cover 440 opened at an angle of 30 degrees is Fa when the operation force acting on the nearly-closed access cover 440 is close to 0. Here, a gas spring generally has a constant maximum value of a repulsion force (gas reaction force). Thus, if an elastic member, such as the gas springs 1500, is used in a conventional manner, the elastic force of each gas spring 1500 is excessive by an amount corresponding to the ink weight when the ink tank 66 is empty. As indicated by a dashed line in FIG. 23, an operation force Fb greater than the operation force Fa is used at the same opening angle. In other words, in a case where an elastic member, e.g., the gas springs are used, the operation force fluctuates as illustrated in FIG. 23 depending on a change in the remaining amount of ink. On the other hand, as described in the present exemplary embodiment, in a case where the gas springs are used as an auxiliary unit in addition to the transmission unit having a self-locking function, the impact of fluctuations of the operation force can be reduced to improve the operability.

According to the present disclosure, an ink jet recording apparatus with higher operability can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-074130, filed Apr. 30, 2024, which is hereby incorporated by reference herein in its entirety.

What is claimed is:

1. An ink jet recording apparatus comprising:
a conveyance path configured to convey a recording medium;
an action unit configured to act on the recording medium, capable of being opened and closed to the conveyance path;
a driving input unit to which driving force for opening and closing the action unit is input; and
a transmission unit configured to transmit the driving force to the action unit from the driving input unit,
wherein the transmission unit includes a locking unit configured to prevent the action unit in an opened state from being closed.

2. The ink jet recording apparatus according to claim 1, wherein one side of the action unit serves as a fulcrum, and the other side of the action unit is moved to open and close.

3. The ink jet recording apparatus according to claim 1,
wherein the action unit is an access cover capable of being opened and closed to the conveyance path,
wherein the transmission unit includes a moving member that acts in opening/closing directions of the action unit with the driving force, and
wherein the moving member is arranged on one side of a sheet width direction orthogonal to a conveyance direction of the recording medium.

4. The ink jet recording apparatus according to claim 3, wherein the moving member is arranged on a side opposite to a side to which the action unit is opened.

5. The ink jet recording apparatus according to claim 1, wherein time taken to move the action unit from a state where the action unit is closed with respect to the conveyance path to a state where the action unit is opened with respect to the conveyance path is shorter than time taken to input the driving force to the driving input unit.

6. The ink jet recording apparatus according to claim 1, wherein an ink containing unit for storing ink used to form an image on the recording medium is arranged over an upper part of the action unit.

7. The ink jet recording apparatus according to claim 1, wherein the action unit is a drying unit having a heating mechanism for drying ink applied to the recording medium.

8. The ink jet recording apparatus according to claim 1, wherein the action unit is a cooling unit having a cooling mechanism for cooling the recording medium.

9. The ink jet recording apparatus according to claim 1, wherein the action unit is a fixing unit having a fixing mechanism for fixing ink applied to the recording medium.

10. The ink jet recording apparatus according to claim 1, wherein a cover member is arranged at a position opposite to a side of the action unit facing the conveyance path, in a case where the unit is closed.

11. The ink jet recording apparatus according to claim 1, wherein the locking unit includes a trapezoidal thread.

12. The ink jet recording apparatus according to claim 1, wherein the locking unit includes a worm gear and a worm wheel.

13. The ink jet recording apparatus according to claim 3, wherein the unit includes an elastic member that acts in a direction against an own weight of the action unit, in a case where the action unit is opened.

14. The ink jet recording apparatus according to claim 13, wherein the elastic member is arranged at a position opposite to the moving member, across a gravity center position of the action unit.

15. The ink jet recording apparatus according to claim 1,
wherein the driving input unit is a handle, and
wherein the handle is driven by a manual operation performed by a user.

16. The ink jet recording apparatus according to claim 15, wherein the handle is attachable to and detachable from the ink jet recording apparatus.

17. The ink jet recording apparatus according to claim 15, wherein the handle includes a first form in a case where the user manually operates the handle, and a second form in another case.

18. The ink jet recording apparatus according to claim 1, wherein the driving force generated by a motor is input to the driving input unit.

19. The ink jet recording apparatus according to claim 1, wherein an opening angle of the action unit includes a second angular range wider than a first angular range operable for the user.

20. The ink jet recording apparatus according to claim 19, wherein the second angular range is an angular range operable for the user in replacing a component.
